(19) United States
(12) Patent Application Publication
(10) Pub. No.: US 2006/0146205 A1
(43) Pub. Date: Jul. 6, 2006

(54) Single-frequency multimode analog display

(76) Inventor: Jui-Ching Tang, Taipei Hsien (TW)

Correspondence Address: BERENATO, WHITE & STAVISH, LLC, 6550 ROCK SPRING DRIVE, SUITE 240, BETHESDA, MD, 20817, US

(21) Appl. No.: 11/102,875

(22) Filed: Apr. 11, 2005

(30) Foreign Application Priority Data
Jan. 6, 2005 (TW) 94100356

(51) Int. Cl. H04N 9/16; H04N 9/22

(52) U.S. Cl. 348/808; 348/810

(57) ABSTRACT

A single-frequency multimode display includes: a display screen; an electron gun; horizontal and vertical deflection circuits for controlling deflection of an electron beam emitted from the electron gun; a single-frequency control unit for receiving a display signal including image content, and horizontal and vertical synchronization (sync) signals; and a deflection control unit coupled to the single-frequency control unit, and the horizontal and vertical deflection circuits. The single-frequency control unit scales the image content to a predetermined resolution, and replaces the horizontal sync signal with a fixed horizontal sync signal. The deflection control unit generates horizontal and vertical deflection signals that correspond to the fixed horizontal sync signal and the vertical sync signal. The horizontal and vertical deflection signals drive the horizontal and vertical deflection circuits such that scanning of the electron beam is controlled.

### BACKGROUND OF THE INVENTION

1. Field of the Invention

The present invention relates to a single-frequency multimode analog display, and more particularly, to an analog display that can accept an analog or digital display signal of various display modes and perform scaling of image content contained in the received display signal to a predetermined resolution, and manipulate deflection signals to realize optimal scanning.

2. Description of the Related Art

Graphics cards for computer systems have changed from being able to generate a single display mode (i.e., a single resolution, such as 640×480 pixels) to being able generate multiple modes, such as 800×600, 1024×768, and 1280×1024 pixels. Therefore, the conventional cathode-ray tube (CRT) requires circuitry to allow for receipt and display (on a screen of the CRT) of image content of different modes from the graphics card. FIG. 1 shows a block diagram of a conventional multi-frequency multimode CRT. The CRT includes a video graphics array (VGA) connector 10 that receives an analog display signal from a graphics card (not shown). The VGA connector 10 inputs to a microprocessor 11 a horizontal synchronization signal (Hsync) and a vertical synchronization signal (Vsync) contained in the display signal, and transmits to a preamplifier/on-screen display (OSD) generating circuit 12 image content contained in the display signal.

The preamplifier/OSD generating circuit 12 amplifies the image content, and inserts an OSD screen in the image content after receiving a corresponding instruction from the microprocessor 11. The preamplifier/OSD generating circuit 12 then outputs the resulting signal to a power amplifier 13 to undergo further amplification. The amplified signal is output to an electron gun 14.

Occurring simultaneously as the above, the microprocessor 11 outputs the horizontal synchronization signal (Hsync) and the vertical synchronization signal (Vsync) to a deflection controller 15, which, according to the horizontal synchronization signal (Hsync), generates different control parameters and supplies the same to a horizontal driver 16, a horizontal screen adjuster 17, a horizontal deflection voltage adjusting circuit 18, and a CS switching circuit 23. The horizontal driver 16 generates a horizontal deflection signal, and inputs this signal to a power amplifier 19. The horizontal screen adjuster 17 performs adjustment of a screen horizontal direction and peripheral linearity on the basis of the horizontal deflection signal. The horizontal deflection voltage adjusting circuit 18 generates a control signal to perform frequency adjustment, then outputs the control signal to a horizontal deflection circuit (coil) 20 to drive the same. As a result, a horizontal scanning signal is generated to realize horizontal deflection of an electron beam emitted from the electron gun 14. The CS switching circuit 23 is connected to the horizontal deflection circuit 20, and adjusts the horizontal scanning signal according to the display signal of different modes, thereby non-linearly executing compensation with respect to the screen.

In addition, the deflection controller 15 generates a vertical deflection signal according to the vertical synchronization signal (Vsync), and transmits the generated vertical deflection signal to a power amplifier 21. The power amplifier 21 amplifies the vertical deflection signal, then outputs the resulting signal to a vertical deflection circuit (coil) 22 to drive the same. As a result, a vertical scanning signal is generated to realize vertical deflection of the electron beam emitted from the electron gun 14. Hence, the electron gun 14 performs scanning and outputting of image content according to the horizontal synchronization signal (Hsync) and the vertical synchronization signal (Vsync) of the input display signal.

Further, the horizontal and vertical deflection circuits 20, 22 cooperate with a linear control coil (not shown), and by varying their inductances, correspond with different horizontal and vertical synchronization signal frequencies.

Therefore, when there are variations in the display mode of the input display signal, for example, a change from a resolution of 640×480 pixels to 800×600 pixels, it is necessary that there be a corresponding increase in the vertical synchronization signal and horizontal synchronization signal (e.g., an increase respectively from 60 Hz to 70 Hz and from 31 kHz to 38 kHz). At this time, the deflection controller 15 must control the horizontal driver 16 such that the frequency of the horizontal deflection signal is appropriately adjusted, and must also control the horizontal screen adjuster 17 such that a width (since the horizontal synchronization frequency is increased, the display screen narrows) and peripheral linearity of image displayed on the display screen are appropriately adjusted. The deflection controller 15 also controls the horizontal deflection voltage adjusting circuit 18 and the CS switching circuit 23 to adjust the voltage level of the horizontal deflection signal (since the power consumption of the horizontal deflection circuit 20 may increase with frequency), as well as the linearity thereof (since the horizontal deflection signal includes non-linear properties). As a result, the power amplifier 19 can, according to different resolutions, generate a corresponding horizontal deflection signal to control the horizontal deflection circuit 20 to enable display of different resolutions on the screen.

However, to allow for such display of different resolutions, the conventional analog display includes the horizontal screen adjuster 17, the horizontal deflection voltage adjusting circuit 18, and the CS switching circuit 23, as well as circuits such as linear control coils to control the inductance levels of horizontal and vertical deflection circuits. Hence, not only is a significant amount of power consumed as a result of the large number of elements involved, but during manufacture of the display, significant costs, time, and effort must go into adjusting and testing to realize optimal conditions for each of the display modes, thereby ultimately resulting in increased manufacturing costs.

### SUMMARY OF THE INVENTION

The object of this invention is to provide a single-frequency multimode analog display that is capable of accepting both analog and digital display signals of various display modes and performing scaling of image content contained in the received display signal to a predetermined resolution, as well as manipulating deflection signals to realize optimal scanning.

The single-frequency multimode display comprises: a display screen; an electron gun for emitting an electron beam toward the display screen; a horizontal deflection circuit and a vertical deflection circuit for controlling deflection of the electron beam emitted from the electron gun; a single-frequency control unit for receiving a display signal including initial image content, a horizontal synchronization signal, and a vertical synchronization signal; and a deflection control unit coupled to the single-frequency control unit, the horizontal deflection circuit, and the vertical deflection circuit

The single-frequency control unit (a) scales the initial image content to a predetermined resolution to thereby obtain scaled image content, and outputs the scaled image content to the electron gun, (b) replaces the horizontal synchronization signal of the display signal with a fixed horizontal synchronization signal, and (c) outputs the fixed horizontal synchronization signal and the vertical synchronization signal of the display signal.

The deflection control unit generates, simultaneously with the output of the electron beam from the electron gun, a horizontal deflection signal and a vertical deflection signal that correspond respectively to the fixed horizontal synchronization signal and the vertical synchronization signal from the single-frequency control unit. The horizontal deflection signal and the vertical deflection signal respectively drive the horizontal deflection circuit and the vertical deflection circuit such that the electron beam from the electron gun scans the display screen so that images are displayed thereon at the predetermined resolution.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a conventional multi-frequency multimode CRT;

FIG. 2 is a block diagram of a single-frequency multimode analog display according to a preferred embodiment of the present invention; and

FIG. 3 is a detailed block diagram of a single-frequency control element of FIG. 2.

### DETAILED DESCRIPTION OF THE PREFERRED EMBODIMENT

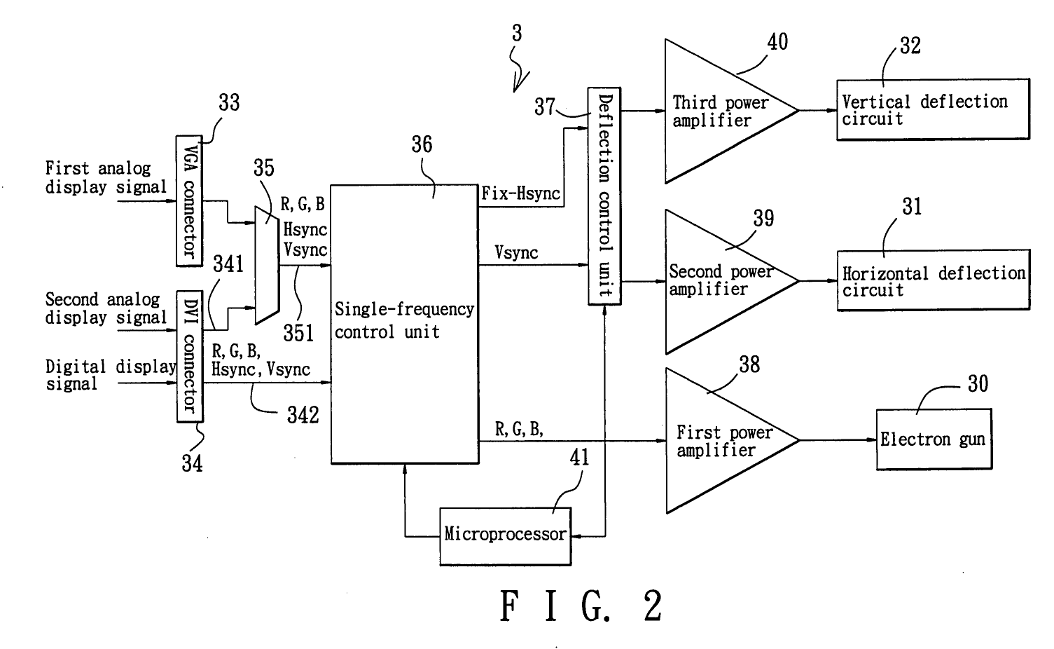

With reference to FIG. 2, a single-frequency multimode analog display 3 according to a preferred embodiment of the present invention may be a cathode-ray tube (CRT) or a high-definition television (HDTV) capable of displaying analog signals. It is assumed in the following for illustrative purposes that the analog display 3 of the preferred embodiment is a CRT.

The single-frequency multimode display 3 includes a display screen (not shown), an electron gun 30, a horizontal deflection circuit 31, a vertical deflection circuit 32, a video graphics array (VGA) connector 33, a digital video interface (DVI) connector 34, a multiplexer 35, a single-frequency control unit 36, a deflection control unit 37, a first power amplifier 38, a second power amplifier 39, a third power amplifier 40, and a microprocessor 41.

The electron gun 30 emits an electron beam toward the display screen to excite phosphors coated on an inner surface of the display screen. The horizontal deflection circuit 31 and the vertical deflection circuit 32 control deflection of the electron beam emitted from the electron gun 30 such that the electron beam scans the display screen, thereby realizing the display of images on the screen. Processing of the signals supplied respectively to the electron gun 30, the horizontal deflection circuit 31, and the vertical deflection circuit 32 to enable such scanning of the display screen by the electron beam will now be described.

The VGA connector 33 and the DVI connector 34 are coupled to a graphics card of a computer (not shown) to receive signals. That is, the VGA connector 33 receives a first analog display signal, and the DVI connector 34 receives both a second analog display signal and a digital display signal. Each of the first and second analog display signals, as well as the digital display signal includes image content (i.e., gray scale information), a horizontal synchronization signal (Hsync), and a vertical synchronization signal (Vsync) The VGA connector 33 is coupled to the multiplexer 35 for outputting the first analog display signal thereto. The DVI connector 34 includes an analog output terminal 341 coupled to the multiplexer 35 for outputting the second analog display signal thereto, and a digital output terminal 342 coupled to the single-frequency control unit 36 for outputting the digital display signal thereto.

The multiplexer 35 is operable so as to select one of the first analog display signal from the VGA connector 33 and the second analog display signal from the analog output terminal 341 of the DVI connector 34. The multiplexer 35 includes an output terminal 351 coupled to the single-frequency control unit 36. The multiplexer 35 outputs the selected one of the first and second analog display signals to the single-frequency control unit 36 via the output terminal 351.

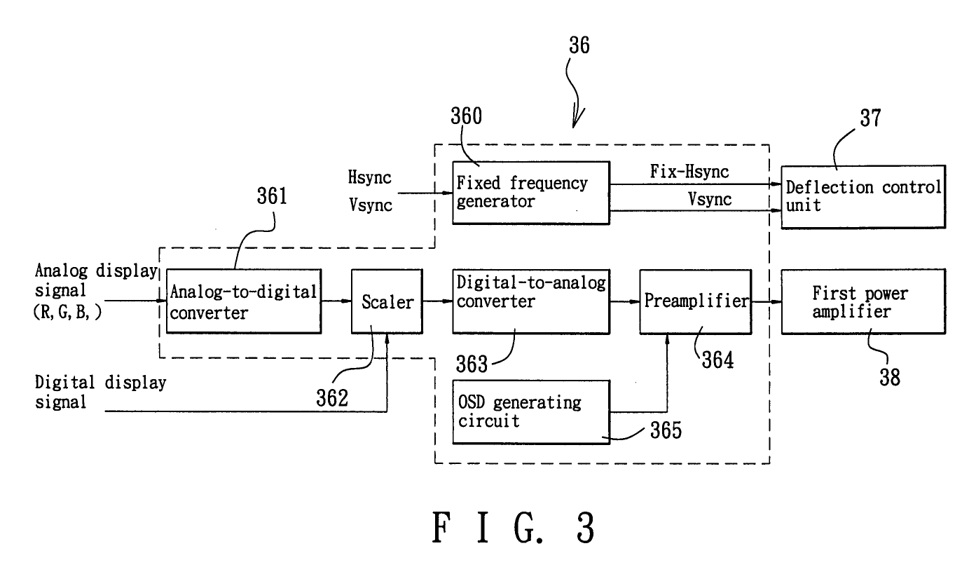

With reference to FIG. 3, the single-frequency control unit 36 includes a fixed frequency generator 360, an analog-to-digital converter (ADC) 361, a scaler 362, a digital-to-analog converter (DAC) 363, a preamplifier 364, and an OSD generating circuit 365.

The fixed frequency generator 360 receives the horizontal synchronization signal (Hsync) and the vertical synchronization signal (Vsync) of the selected analog display signal, and generates a fixed horizontal synchronization signal (Fix-Hsync), such as a 90 kHz signal. The fixed frequency generator 360 replaces the horizontal synchronization signal (Hsync) of the selected analog display signal with the fixed horizontal synchronization signal (Fix-Hsync), while the vertical synchronization signal (Vsync) is maintained unchanged. The fixed frequency generator 360 outputs the fixed horizontal synchronization signal (Fix-Hsync) and the vertical synchronization signal (Vsync) to the deflection control unit 37.

The ADC 361 is coupled to the multiplexer 35, and acts to convert the image content contained in the received selected analog display signal into digital form to thereby obtain what will be referred to as initial image content. The ADC 361 transmits the initial image content to the scaler 362. The scaler 362 is also coupled to the digital output terminal 342 of the DVI connector 34, and when the display signal is digital, the image content contained in the digital display signal is used directly as the initial image content.

The scaler 362 performs scaling of the initial image content to result in scaled image content of a predetermined resolution. That is, the initial image content has an intrinsic resolution, and the scaler 362 scales the initial image content on the basis of the intrinsic resolution of the initial image content. The scaler 362 performs scaling using conventional upconversion and downconversion techniques involving interpolation. Since these scaling processes are conventional, a detailed description thereof will not be provided.

The scaled image content is input to the DAC 363 by the scaler 362. The DAC 363 converts the data into analog form to thereby obtain analog-converted image content. The DAC outputs the analog-converted image content to the preamplifier 364, which amplifies the analog-converted image content to obtain preamplified image content. The preamplifier 364 then outputs the preamplified image content to the first power amplifier 38, which performs amplification of the preamplified image content, then outputs resulting image content to the electron gun 30.

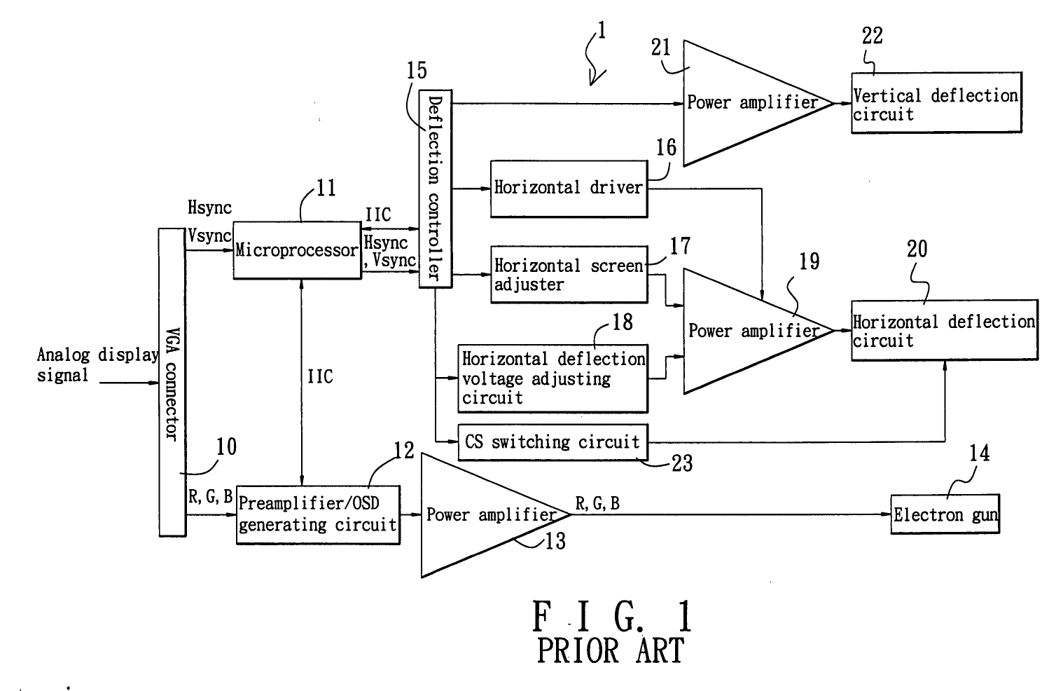

The OSD generating circuit 365 of the single-frequency control unit 36 is coupled to the preamplifier 364, and operates according to instructions received from the microprocessor 41 (see FIG. 1). That is, after receiving an instruction from the microprocessor 41, the OSD generating circuit 365 inserts an OSD screen into the analog-converted image content being processed by the preamplifier 364 such that the OSD screen is contained in the image content received by the electron gun 30. Hence, user control of viewing options and/or adjustment of components of the display is provided.

The deflection control unit 37 generates a horizontal deflection signal and a vertical deflection signal that correspond respectively to the fixed horizontal synchronization signal (Fix-Hsync) and the vertical synchronization signal (Vsync). The horizontal deflection signal and the vertical deflection signal are respectively output to the second power amplifier 39 and the third power amplifier 40 to undergo amplification. The amplified signals are used to drive the horizontal deflection circuit 31 and the vertical deflection circuit 32 such that the electron beam from the electron gun 30 scans the display screen so that images are displayed thereon at the predetermined resolution.

In the present invention described above, the scaler 362 of the single-frequency control unit 36 is able to scale the image content, which is received from the graphics card having an intrinsic resolution, to the predetermined resolution. Further, the single-frequency control unit 36 performs control such that the fixed horizontal synchronization signal (Fix-Hsync) replaces the existing horizontal synchronization signal. The fixed horizontal synchronization signal (Fix-Hsync) and the existing vertical synchronization signal (Vsync) are used to control the deflection and scanning of the electron beam emitted from the electron gun 30. As a result, the resolution of the image content appearing on the screen remains constant.

With the configuration described above, various elements found in the conventional CRT shown in FIG. 1 are omitted including the horizontal screen adjuster 17, the horizontal deflection voltage adjusting circuit 18, the CS switching circuit 23, and the control coil. This results in a simpler overall structure and hence lower manufacturing costs, as well as lower power consumption.

Further, since the horizontal synchronization signal is fixed at a single frequency, mode adjusting and measurement operations are made simple. Hence, it is possible to realize optimal display through a single resolution adjustment, thereby enhancing reliability and manufacturing efficiency. In addition, since the horizontal synchronization signal is not varied, the circuitry of the deflection control unit 37 may be simplified.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A single-frequency multimode display, comprising:
a display screen;
an electron gun for emitting an electron beam toward said display screen;
a horizontal deflection circuit and a vertical deflection circuit for controlling deflection of the electron beam emitted from said electron gun;
a single-frequency control unit for receiving a display signal including initial image content, a horizontal synchronization signal, and a vertical synchronization signal, said single-frequency control unit (a) scaling the initial image content to a predetermined resolution to thereby obtain scaled image content, and outputting the scaled image content to said electron gun, (b) replacing the horizontal synchronization signal of the display signal with a fixed horizontal synchronization signal, and (c) outputting the fixed horizontal synchronization signal and the vertical synchronization signal of the display signal; and
a deflection control unit coupled to said single-frequency control unit, said horizontal deflection circuit, and said vertical deflection circuit, said deflection control unit generating, simultaneously with the output of the electron beam from said electron gun, a horizontal deflection signal and a vertical deflection signal that correspond respectively to the fixed horizontal synchronization signal and the vertical synchronization signal from said single-frequency control unit, the horizontal deflection signal and the vertical deflection signal respectively driving said horizontal deflection circuit and said vertical deflection circuit such that the electron beam from said electron gun scans said display screen so that images are displayed thereon at the predetermined resolution.

2. The single-frequency multimode display of claim 1, wherein said single-frequency control unit includes:
a fixed frequency generator for receiving the horizontal synchronization signal and the vertical synchronization signal of the display signal, and for outputting the predetermined horizontal synchronization signal and the vertical synchronization signal;
a scaler for performing scaling of the initial image content to result in the scaled image content of the predetermined resolution; and
a digital-to-analog converter (DAC) coupled to said scaler, said DAC performing analog conversion of the scaled image content to thereby obtain analog-converted image content.

3. The single-frequency multimode display of claim 2, wherein said single-frequency control unit 36 further includes:
an analog-to-digital converter (ADC) coupled to said scaler for performing digital conversion of an analog display signal to thereby obtain the initial image content that is output to said scaler.

4. The single-frequency multimode display of claim 2, wherein the initial image content of the display signal has an intrinsic resolution, said scaler scaling the initial image content on the basis of the intrinsic resolution of the initial image content.

5. The single-frequency multimode display of claim 2, wherein said single-frequency control unit further includes:
a preamplifier coupled to said DAC to receive the analog-converted image content; and
an on-screen display (OSD) generating circuit coupled to said preamplifier.

6. The single-frequency multimode display of claim 5, further comprising:
a first power amplifier coupled between said electron gun 30 and said preamplifier of said single-frequency control unit, said first power amplifier performing amplification of the preamplified image content from said preamplifier and outputting the resulting image content to said electron gun;
a second power amplifier coupled between said deflection control unit and said horizontal deflection circuit, said second power amplifier performing amplification of the fixed horizontal deflection signal from said deflection control unit and outputting the resulting horizontal deflection signal to said horizontal deflection circuit; and
a third power amplifier coupled between said deflection control unit and said vertical deflection circuit, said third power amplifier performing amplification of the vertical deflection signal from said deflection control unit and outputting the resulting vertical deflection signal to said vertical deflection circuit.

7. The single-frequency multimode display of claim 3, further comprising:
a video graphics array (VGA) connector for receiving a first analog display signal;
a digital video interface (DVI) connector having an analog output terminal and a digital output terminal, said DVI connector receiving a second analog display signal that is output via said analog output terminal, said DVI connector further receiving a digital display signal that is output to said scaler via said digital output terminal; and
a multiplexer coupled to said ADC, said VGA connector, and said analog output terminal of said DVI connector, said multiplexer being operable so as to select one of the first analog display signal from said VGA connector and the second analog display signal from said analog output terminal of said DVI connector, and outputting the selected one of the first and second analog display signals to said ADC.

8. The single-frequency multimode display of claim 1, further comprising:
a video graphics array (VGA) connector for receiving a first analog display signal;
a digital video interface (DVI) connector having an analog output terminal and a digital output terminal, said DVI connector receiving a second analog display signal that is output via said analog output terminal, said DVI connector further receiving a digital display signal that is output to said single-frequency control unit via said digital output terminal; and
a multiplexer coupled to said single-frequency control unit, said VGA connector, and said analog output terminal of said DVI connector, said multiplexer being operable so as to select one of the first analog display signal from said VGA connector and the second analog display signal from said analog output terminal of said DVI connector, and outputting the selected one of the first and second analog display signals to said single-frequency control unit.
